(19) United States
(12) Patent Application Publication
(10) Pub. No.: US 2017/0201031 A1
(43) Pub. Date: Jul. 13, 2017

(54) ARTICLE AND METHOD OF FORMING AN ARTICLE

(71) Applicant: THE SECANT GROUP, LLC, Telford, PA (US)

(72) Inventors: Todd J. GELB, Chalfont, PA (US); Sean Christopher GLASBY, Perkasie, PA (US); Daniel P. TREUSCH, Jr., Lansdale, PA (US)

(21) Appl. No.: 15/400,453

(22) Filed: Jan. 6, 2017

Related U.S. Application Data
(60) Provisional application No. 62/276,459, filed on Jan. 8, 2016.

(51) Int. Cl. H01Q 15/16; H01Q 1/40; H01Q 1/28; H01Q 1/36; H01Q 13/02

(52) U.S. Cl. CPC H01Q 15/161; H01Q 1/368; H01Q 13/0283; H01Q 1/288; H01Q 1/40; H01Q 15/168

(57) ABSTRACT

A shape memory alloy article and method a deploying the article in deep space is provided. The shape memory alloy article may be an interlaced mesh structure. The article may be stored in a deformed configuration in a container for transport aboard a satellite or spacecraft. Upon reaching a desired location the article is removed from the container and heated to allow for transformation to an operating configuration.

### RELATED APPLICATIONS

This application claims the benefit of and priority to U.S. application Ser. No. 62/276,459, filed Jan. 8, 2016, which is hereby incorporated by reference in its entirety.

### FIELD OF THE INVENTION

This application is directed to an article and a method of forming a shaped article formed with a shape memory alloy and a method of forming a shaped article with a shape memory alloy and more particularly to space-based antennae formed of a shape memory alloy.

### BACKGROUND OF THE INVENTION

Information is often transmitted and received through various signal formats. Generally, transmission and reception of these signals is effected through one or more antennae. These antennae are typically formed from conductive materials and include many different shapes and/or sizes. For example, portable radios and other small electronics commonly include monopole antennas, which may consist of a metal rod or other single radiating element.

In certain applications, the antennae are constructed for use in a specific environment or for a specific purpose. One such antenna includes a satellite antenna for deep space radio transmission and reception. While these antennae are suitable for deep space use, they are usually configured in a rigid radial ribbed un-furlable reflector array which is integrated into the satellite structure. In order for the reflector to demonstrate the required characteristics of the un-furlable actuators, a series of connecting rods, struts, and electronic devices must be attached to the array. Operating these actuators requires complex software programming that must be written to sequence the antenna deployment. This complex programming and series of moving parts increases the potential for failure in the deployment of the antenna array.

Additionally, the connecting rods, struts, and electronic devices add weight to the antenna. Adding weight to the antenna increases the overall weight of the satellite, which significantly increases cost. Furthermore, increases in weight due to the antenna decrease the amount of scientific payload that can be secured to the satellite, which decreases functionality of the satellite and ultimately increases cost.

These and other drawbacks are associated with current articles and methods for forming articles.

### BRIEF DESCRIPTION OF THE INVENTION

Exemplary embodiments are directed to an article and a method of forming an article.

According to an exemplary embodiment, an article includes a shape memory alloy and a coating material applied over the shape memory alloy, the shape memory alloy forming a deformable body portion of the article.

According to another exemplary embodiment, a method of forming an article includes coating a shape memory material with a coating material, the coating material and the shape memory material forming a coated wire, manipulating the coated wire to form a deformable body portion, and heat setting the deformable body portion with a non-deformed base configuration. The coating material forms a conductive surface over the shape memory alloy.

According to another exemplary embodiment, a method of forming an article includes manipulating a shape memory alloy to form a deformable body portion, heat setting the deformable body portion with a non-deformed base configuration, and coating the body portion with a coating material. The coating material forms a conductive surface over the shape memory alloy.

According to another exemplary embodiment, an antenna includes a deformable antenna body. The body includes a knit or woven mesh, constructed of a shape memory alloy. The shape memory alloy is coated with gold, silver, carbon nanotubes, graphene, or combinations thereof.

According to another exemplary embodiment, a method of deploying an antenna includes manipulating a shape memory alloy to form a deformable body portion, heat setting the deformable body portion with a non-deformed base configuration configured as an antenna, deforming the deformable body portion and deploying the antenna.

Among the advantages of exemplary embodiments is that methods described herein produce an article having shape memory properties that may be deployed in space.

Another advantage is that the exemplary embodiments permit storage of the article in areas of decreased size as compared to non-shape memory articles.

Still another advantage is that the exemplary embodiments decrease an amount of mechanical aids necessary for deployment of the article.

A further advantage is that the exemplary embodiments decrease an amount of electrical aids necessary for deployment of the article.

Another advantage is that the exemplary embodiments decrease manufacturing cost of the article.

Yet another advantage is that the exemplary embodiments decrease an overall weight of products, such as satellites, that include the article.

Other features and advantages of the present invention will be apparent from the following more detailed description of exemplary embodiments that illustrate, by way of example, the principles of the invention.

### BRIEF DESCRIPTION OF THE DRAWINGS

FIG. 1 shows a perspective view of an article, according to an embodiment of the disclosure.

FIG. 2A shows an enlarged view of a portion of the article of FIG. 1 including a tricot knit, according to an embodiment of the disclosure.

FIG. 2B shows an enlarged view of a portion of the article of FIG. 1 including a leno weave, according to an embodiment of the disclosure.

FIG. 3 shows a process view of an article deploying from a product, according to an embodiment of the disclosure.

Wherever possible, the same reference numbers will be used throughout the drawings to represent the same parts.

### DETAILED DESCRIPTION OF EXEMPLARY EMBODIMENTS

Exemplary embodiments are directed to an article and a method of forming an article. Embodiments of the present disclosure, in comparison to articles and methods not using one or more of the features disclosed herein, provide an antenna with shape memory properties, provide an antenna suitable for storage in small spaces, provide an antenna capable of being deployed in space, decrease or eliminate mechanical aids for deployment of the antenna, decrease or eliminate electrical aids for deployment of the antenna, decrease programming requirements for a deployment sequence, decrease cost, decrease weight, and combinations thereof.

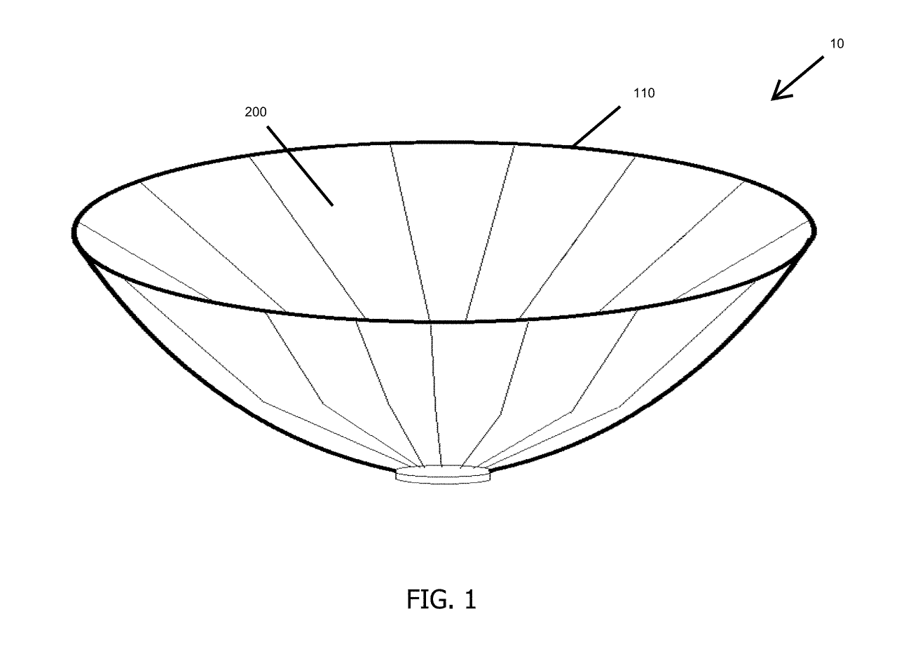

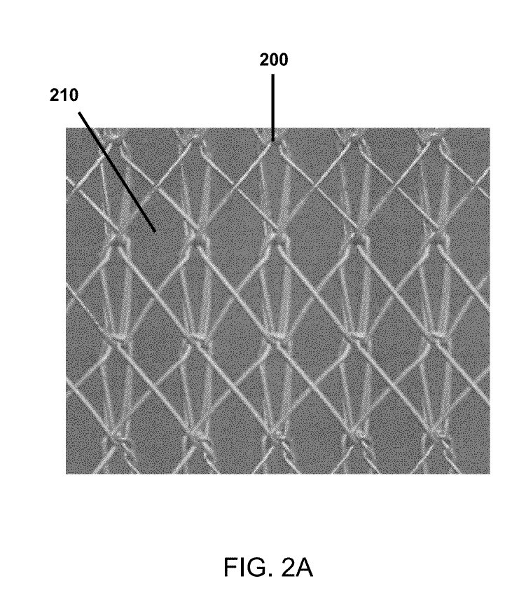

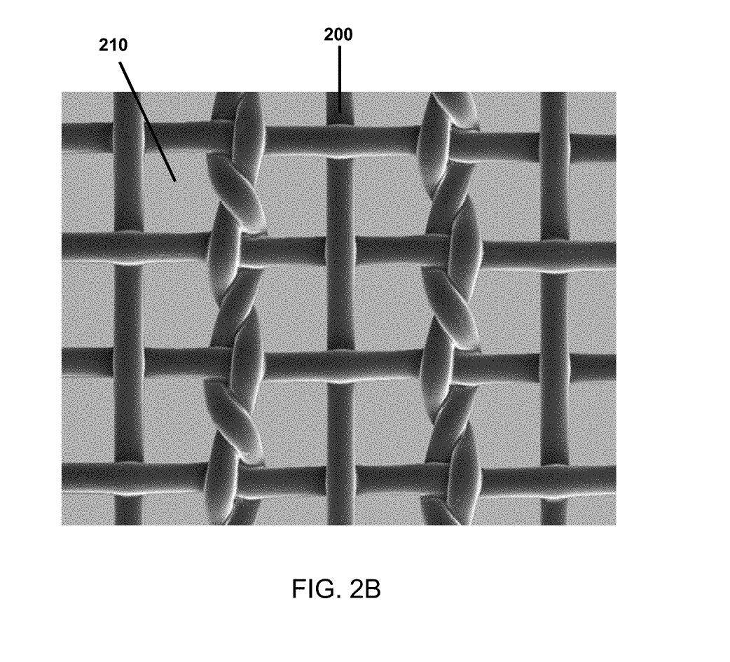

As provided herein, an article includes a shape memory material coated with a coating material that provides one or more desired properties. In the example of FIGS. 1, 2A, and 2B, an article 10 including a shape memory material is arranged and disposed to provide any suitable shape and/or configuration for the article 10. For example, in one embodiment, the shape memory material of the article 10 includes an interlaced mesh 200 that is arranged and disposed to provide the shape and/or configuration of an antenna 110, such as, but not limited to, an antenna 110 configured for deep space radio transmission and reception. In another embodiment, the coating material is applied over the shape memory material with any suitable thickness for providing the one or more desired properties without decreasing or eliminating the shape memory properties of the shape memory material. As will be understood by those skilled in the art, a shape memory material is any material that exhibits shape memory properties, which include the ability to undergo deformation and then return to, or recover, an original, undeformed shape upon heating above a transformation temperature of the material.

Suitable shape memory materials include, but are not limited to, any shape memory alloy (SMA) having a transformation temperature that is within a range of expected operating temperatures for the article 10. For example, the shape memory material of the antenna 110 described above may include metal alloys having one or more of aluminum, chromium, copper, hafnium, iron, manganese, nickel, palladium, silicon, titanium, zinc, zirconium, and combinations thereof. In one embodiment, the shape memory material includes a metal alloy of nickel and titanium (Ni—Ti), also known to those skilled in the art as Nitinol, having a composition, by weight, of between 50% and 60% nickel, and between 40% and 50% titanium. Suitable Nitinol shape memory alloys include, but are not limited to, Nitinol 55 (55% Ni and 45% Ti, by weight), Nitinol 60 (60% Ni and 40% Ti, by weight), or a combination thereof. These Nitinol shape memory alloys recover their original, un-deformed shape at temperatures within the operating temperatures of satellites that may include the antenna 110. In other embodiments, the shape memory material may include but is not limited to alloys such as Ni—Ti—Au, Ni—Ti—Hf, Ni—Ti—Pd, Ni—Ti—Pt, Ni—Ti—Zr, Cu—Al—Ni, Cu—Al—Ni—B, Cu—Zn—Al, Fe—Mn—Al—Ni, Fe—Mn—Si—Cr—Ni, and combinations thereof. Additionally, in contrast to other alloys, such as gold and cadmium alloys that may be too brittle to form the article 10, shape memory materials, such as Nitinol, exhibit super elasticity (SE), or pseudo-elasticity (PE), within a range of temperatures above its transition temperature. Super elasticity, as used herein, includes elasticity of at least 10 to 30 times that of ordinary metals within the same temperature range.

Other suitable shape memory materials include, but are not limited to, shape memory polymers, shape memory resins, or a combination thereof. Suitable memory shape resins or polymers include, for example, but are limited to, hydrogels of formed from copolymerized acrylic acid and stearyl acrylate cross-linked with methylenebisacrylamides, styrene copolymers, and Maleimide-Based High-Temp resin.

Suitable coating materials include any coating material for providing the one or more desired properties of the article 10. For example, one suitable coating material includes an electrically conductive coating material, such as, but not limited to, gold, silver, copper, graphene, or carbon nanotubes. In some embodiments, the thickness of coating material may be between about 1 nanometer and about 100 nanometers.

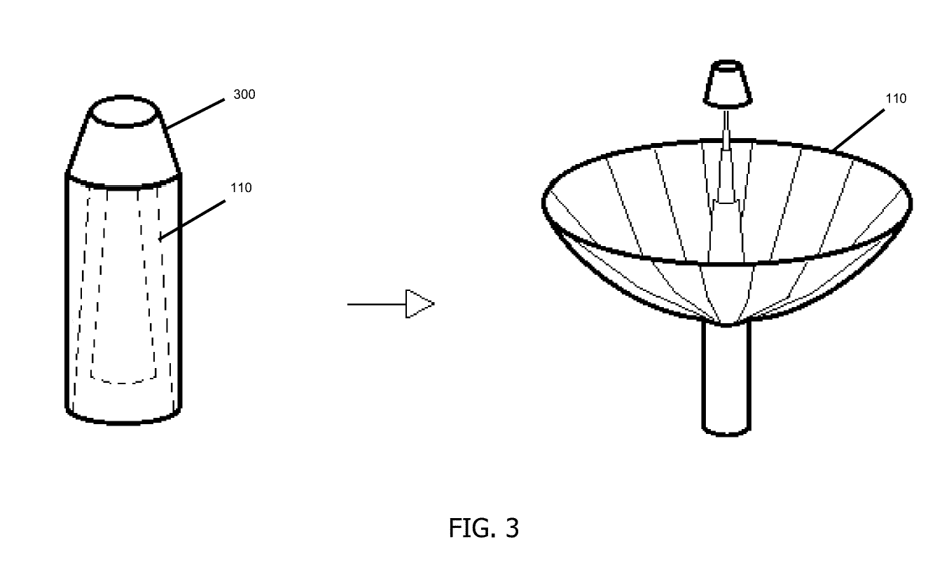

In one embodiment, as illustrated in FIG. 3, the shape memory properties of the shape memory material permit confinement and deployment of the article 10. In another embodiment, the electrically conductive coating material over the shape memory material increases electrical conductivity as compared to uncoated shape memory materials, such as uncoated Nitinol, which provide the desired conductivity to operate as an antenna 110, which may be constructed as a parabolic antenna. In a further embodiment, the electrically conductive coating material decreases Passive Intermodulation Generation (PIM) as compared to an uncoated shape memory material, which provides improved antenna 110 functionality. For example, the shape memory material coated with the electrically conductive coating material may be arranged and disposed to form an antenna 110 that is confinable in and deployable from a satellite operating in deep space.

Forming the article 10 includes any suitable process for arranging and disposing the shape memory material in the shape and/or configuration of the article 10. For example, in one embodiment, forming the article 10 includes creating a wire having a shape memory material core with a coating material applied thereover, manipulating the wire to form a body portion, and optionally processing the body portion to set an original shape of the article 10. In another embodiment, creating the wire includes applying the coating material over the shape memory material. In a further embodiment, such as when applying a gold coating over a shape memory alloy, the applying of the coating material creates a co-alloy wire. Additionally or alternatively, the process of forming the article 10 may include applying the coating material to the shape memory material after manipulating the shape memory material to form the body portion.

The creating of the wire and/or the applying of the coating material includes any suitable application method for coating the shape memory material and/or exposed sections of the body portion with the coating material. Suitable application methods include, but are not limited to, drawn filled tube application, plating, or a combination thereof.

The manipulating of the wire and/or the shape memory material includes forming an interlaced and/or mesh 200 with a pattern that decreases and/or minimizes Passive Intermodulation Generation (PIM) that may result from metal to metal contact points. Suitable methods for forming the interlaced mesh 200 include, but are not limited to, knitting, weaving, and/or braiding of the wire. For example, FIG. 2A illustrates the interlaced mesh 200 as a tricot knit, while FIG. 2B illustrates the interlaced mesh as a leno weave. Other knitted, woven or braid constructions may also be employed.

In one embodiment, the wire and/or shape memory material is warp knit on a fully threaded 20 gauge tricot machine using two bars with a 1-0/1-2 pattern on the first bar and a 1-2/1-0 pattern on the second bar. Although described above with a fully threaded 20 gauge tricot machine with 1-0/1-2 and 1-2/1-0 patterns, as will be appreciated by those skilled in the art, the tricot knitting is not so limited and may include any other suitable gauge, threading, and/or pattern. In another embodiment, the wire and/or shape memory material is warp knit in a tubular form on a circular warp knit machine.

In a further embodiment, the wire and/or shape memory material is woven in a leno pattern mimicking the knit mesh described above. Depending on the size and structure of the wire and/or shape memory material, the manipulating may also include applying a processing lubricant to the wire and/or shape memory material (e.g., when using small diameters, such as 1 to 1.2 mil, or when manipulating gold coated wire).

After manipulating the wire and/or the shape memory material, the optional processing of the resulting interlaced and/or mesh 200 includes setting a pre-formed, base, and/or original shape of the body portion. Suitable methods for setting the shape of the body portion include, but are not limited to, thermoforming, curing, any other method of imparting a pre-formed, base, and/or original shape to the body portion, or a combination thereof. For example, in one embodiment, setting the shape of the body portion includes placing the body portion over a mandrel and then heat-setting the body portion in a heated furnace and/or through any other application of heat to the body portion. In another embodiment, setting the shape of the body portion includes placing the body portion over the mandrel and then freezing the body portion in a cryogenic freeze chamber and/or through any other application of cold to the body portion.

During the setting of the shape, the mandrel provides the pre-formed, base, and/or original shape of the body portion, and includes any suitable geometry based upon the article 10 being formed (e.g., a geometry corresponding to the desired shape of an antenna 110). In embodiments, during the setting of the shape, the materials of the shape memory alloy are heated above a transformation temperature to form an austenite structure. In one embodiment, at least a portion of the shape memory alloy is set in an austenite structure. In a further embodiment, substantially all of the shape memory alloy is set in the austenite structure.

Once set, the article 10 may be cooled to below the transformation temperature to allow the shape memory alloy to transform to a martensite structure while in the desired shape. In one embodiment, at least a portion of the shape memory alloy is transformed to the martensite structure. In a further embodiment, substantially all the shape memory alloy is transformed to the martensite structure.

The article 10 may be removed from the mandrel and attached to a final product, such as a satellite. In one embodiment, the article 10 may be configured to function as an antenna 110, set in an operating configuration, and deformed for storage within the satellite or spacecraft. Upon reaching a desired location (e.g., a desired orbit) the shape memory antenna 110 may be removed from storage and deployed. During deployment the shape memory antenna 110 may be heated to allow for transformation to the operating configuration.

In the example of FIG. 3, the article 10 is configured as the antenna 110 and stored in a storage container 300 in a deformed configuration for transport aboard a satellite and/or spacecraft. Upon reaching a desired location (e.g., a desired orbit) the shape memory antenna 110 may be deployed by removing the antenna 110 from the storage container 300 and heating the antenna 110 to allow the shape memory alloy of the antenna 110 to undergo transformation to the operating configuration. The heating of the antenna 110 may be performed by any suitable means including electrical heating and/or exposure to solar radiation.

In some embodiments, at least some of the shape memory alloy is transformed to the austenite structure during deployment. In further embodiments, substantially all the shape memory alloy is transformed to the austenite structure during deployment. In some embodiments, the storage container 300 may be discarded after the removal of the antenna 110. In other embodiments, the storage container 300 may provide additional functionally, such as, mechanical support and/or assist in the orientation of the antenna 110.

As compared to current articles, which are typically formed from molybdenum in a rigid radial ribbed un-furlable reflector array that is integrated into the satellite structure, the shape memory material of the article 10 described herein may be deployed with a decreased amount of mechanical and/or electrical aids, such as connecting rods, struts, and/or electronic devices. Decreasing the amount of mechanical and/or electrical aids decreases cost, decreases weight, decreases complex software programming for antenna 110 deployment, decreases the number of steps in the deployment sequence of the antenna 110, decreases the potential for deployment failure, increases deployment reliability, increases a likelihood of successful satellite operation, or a combination thereof.

As compared to current articles, which are typically rigid structures, the shape memory material of the article 10 may be self-healing. For example, an antenna 110 in space may be impacted by micro-meteorites or space debris causing deformation of the antenna 110 and reducing its performance. A deformed shape memory antenna 110 may be subsequently heated to allow the materials to undergo transformation to return to the desired operating configuration thereby regaining some or all of the reduced performance.

Additionally, the shape memory material of the article 10 described herein may be stored within and deployed from a smaller area as compared to current articles that do not include shape memory materials. The smaller storage area of the article 10 decreases overall size of the product including the article 10, which further decreases cost and weight. In one embodiment, the smaller storage area permits decreased satellite size and/or increased scientific payload. For example, the article 10 described herein may be coupled to a CubeSat, which is a space research satellite including multiple 10×10×11.35 cm cubic units and having a mass of no more than 1.33 kilograms per unit. As compared to the composite woven antenna currently utilized in CubeSats, the article 10 described herein provides increased effectiveness, reaches an increased range of bandwidths, provides a decreased antenna 110 size, or a combination thereof.

Furthermore, in contrast to current antennae that include mesh draped and stretched over a metal framework, which may generate variations in mesh openings during folding and unfolding, the shape memory material of the article 10 described herein includes pre-set mesh 200 pore openings 210. These pre-set mesh pore openings 210 decrease variation in pore size, increase pore consistency, and/or increase performance reliability as compared to existing antennae including a mesh draped and stretched over a metal framework. As variation in mesh openings 210 may decrease antenna performance, and certain bandwidths used in communications depend on the gauge, or Openings Per Inch (OPI), of the mesh 200 in order to effectively receive and transmit signals, the decreased variation in pore size and increased pore consistency of the article 10 described herein increase reliability and proper operation of the antenna 110 after storage and deployment thereof. In some embodiments, the mesh opening 210 pore size is at least about 3 openings per centimeter, at least about 3.5 openings per centimeter, at least about 3.9 openings per centimeter, less than about 20 openings per centimeter, less than about 18 openings per centimeter, less than about 16 openings per centimeter, and combinations thereof. In some embodiments, the mesh opening 210 size is between about 10 to about 40 openings per inch.

Although described herein primarily with regard to satellite antennae, the article 10 is not so limited, and may include any other suitable shape and/or structure. Other suitable shapes and/or structures include, but are not limited to, other metallic spacecraft structure, other metallic satellite structures, medical device technologies, automotive technologies, any technology including conductive structures that are exposed to challenging cold and hot thermal conditions, or a combination thereof. For example, the coated shape memory alloy article 10 may form a deployable implantable medical device, such as a stent.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An article comprising a shape memory alloy and a coating material applied over the shape memory alloy, the shape memory alloy forming a deformable body portion of the article.

2. The article of claim 1, wherein the shape memory alloy includes a material selected from the group consisting of aluminum, chromium, copper, gold, hafnium, iron, manganese, nickel, palladium, platinum, silicon, titanium, zinc, zirconium, and combinations thereof.

3. The article of claim 2, wherein the shape memory alloy includes aluminum, copper, and nickel.

4. The article of claim 2, wherein the shape memory alloy includes nickel and titanium.

5. The article of claim 2, wherein the deformable body portion comprises an interlaced mesh.

6. The article of claim 5, wherein the deformable body portion includes a leno weave or a tricot knit.

7. The article of claim 6, wherein the interlaced mesh has between about 3 to about 20 openings per centimeter.

8. The article of claim 7, wherein the deformable body portion is configured as at least a portion of an antenna.

9. The article of claim 1, wherein the deformable body portion is configured as at least a portion of an antenna.

10. The article of claim 1, wherein the coating material is selected from the group consisting of gold, silver, carbon nanotubes, graphene, and combinations thereof.

11. An antenna comprising a deformable antenna body, the body comprising a knit or woven mesh, the mesh constructed of a shape memory alloy coated with gold, silver, carbon nanotubes, graphene, or combinations thereof.

12. The antenna of claim 11, wherein the shape memory alloy includes nickel and titanium.

13. The antenna of claim 11, wherein the coating includes gold.

14. The antenna of claim 11, wherein the deformable body portion includes a leno weave or a tricot knit.

15. A method of forming an article, the method comprising:
providing a coated wire comprising a shape memory alloy having an overlying coating material;
manipulating the coated wire to form a deformable body portion comprising an interlaced mesh; and
heat setting the deformable body portion with a non-deformed base configuration;
wherein the coating material forms a conductive surface over the shape memory alloy.

16. The method of claim 15, wherein the non-deformed body configuration includes a knit or woven configuration.

17. The method of claim 16, wherein the knit or woven configuration includes a leno weave or a tricot knit.

18. The method of claim 15, wherein the interlaced mesh has between about 3 to about 20 openings per centimeter.

19. The method of claim 15, wherein the coating material is selected from the group consisting of gold, silver, carbon nanotubes, graphene, and combinations thereof.

20. The method of claim 19, wherein the coating material includes gold.

21. The method of claim 15, wherein the shape memory alloy includes nickel and titanium.

22. A method of forming an article, the method comprising:
manipulating a shape memory alloy to form a deformable body portion comprising an interlaced mesh;
heat setting the deformable body portion with a non-deformed base configuration; and
coating the body portion with a coating material;
wherein the coating material forms a conductive surface over the shape memory alloy.

23. A method of deploying an antenna, comprising in order:
manipulating a shape memory alloy to form a deformable body portion;
heat setting the deformable body portion with a non-deformed base configuration, wherein the non-deformed base configuration is configured as an antenna;
deforming the deformable body portion; and
deploying the antenna.

24. The method of claim 23, wherein the shape memory alloy comprises nickel and titanium.

25. The method of claim 23, wherein heat setting the deformable body portion converts substantially all of the shape memory alloy to an austenite structure while in the non-deformed base configuration.

26. The method of claim 25, wherein deploying the antenna causes at least a portion of the shape memory alloy to transform to the austenite structure.

27. The method of claim 26, wherein deploying the antenna causes substantially all of the shape memory alloy to transform to the austenite structure.

28. The method of claim 23, wherein deforming the deformable body portion deforms the deformable body portion while the shape memory alloy is in a substantially martensite structure.

29. The method of claim 23, further comprising coating the shape memory alloy.

30. The method of claim 29, wherein the coating comprises gold.
